(19) United States
(12) Patent Application Publication
(10) Pub. No.: US 2025/0225741 A1
(43) Pub. Date: Jul. 10, 2025

(54) INFORMATION PROCESSING DEVICE THAT GENERATES COMBINED IMAGE OF REAL IMAGE AND VIRTUAL IMAGE, AND INFORMATION PROCESSING METHOD

(71) Applicant: CANON KABUSHIKI KAISHA, Tokyo (JP)

(72) Inventors: MINORU SAKAIDA, Kanagawa (JP); RYOSUKE TANAKA, Kanagawa (JP); NAOTO OKUMURA, Kanagawa (JP); KAZUYA INO, Kanagawa (JP)

(21) Appl. No.: 18/985,585

(22) Filed: Dec. 18, 2024

(30) Foreign Application Priority Data
Jan. 9, 2024 (JP) 2024-000971

(51) Int. Cl. G06T 19/00; G02B 27/01; G06V 20/20

(52) U.S. Cl. CPC G06T 19/006; G02B 27/0101; G06V 20/20; G06T 2219/2004

(57) ABSTRACT

An information processing device includes one or more processors and/or circuitry configured to: execute acquiring a real image in which real space is image-captured, execute generating, based on data of a virtual object placed in virtual space, a virtual image representing the virtual space in which the virtual object is placed, execute combining processing of combining the real image and the virtual image, and generating a combined image, and execute control processing in which, based on whether a real object included in the real image and the virtual object included in the virtual image overlap, framing control is performed to adjust positions of the real object and the virtual object in the combined image, wherein, in the combining processing, the real image that is image-captured based on the framing control and the virtual image that is generated based on the framing control are combined.

### BACKGROUND OF THE INVENTION

### Field of the Invention

The present invention relates to an information processing device that generates a combined image of a real image and a virtual image, and to an information processing method.

### Description of the Related Art

In recent years, technology such as augmented reality (AR), mixed reality (MR), and so forth, is being used in various types of equipment. For example, AR technology and MR technology are used in equipment equipped with a camera, such as head-mounted displays (HMD), smartphones, tablet terminals, and so forth.

Such equipment can combine into a single image a real object (hereinafter referred to as “real object”) shot using a camera, and computer graphics representing an object that is virtual and that does not exist in reality (hereinafter referred to as “virtual object”), and can perform displaying, recording, and so forth thereof. AR technology and MR technology is used in games and so forth, for example. Equipment that implements AR and MR can capture an image of a person who is an object, and a virtual character that does not exist in reality, as if these people were in the same space.

Also, image-capturing devices, which, without user operations, are capable of automatically performing control relating to shooting, such as framing, shutter release, and so forth, and autonomously performing shooting operations (hereinafter referred to as “automatic shooting camera”) are in widespread use. Automatic shooting cameras are in widespread use as products for shooting desired locations for crime prevention usage, such as security cameras. In recent years, the usages of automatic shooting cameras have diversified, and there are now available, for individual users, automatic shooting cameras that shoot images of people moving about.

An information processing device described in Japanese Patent Application Publication No. 2018-142273, and an image display device described in Japanese Patent Application Publication No. 2015-007722 presume installation thereof in an HMD capable of MR display, and combine virtual objects on real scenery, and perform presentation thereof. The information processing device described in Japanese Patent Application Publication No. 2018-142273 implements interaction by realizing contact between real objects and virtual objects. This information processing device acquires, as models representing shapes of real objects, two types of models, which are an outline model that expresses a visual outline of the object, and a surface model that expresses the three-dimensional surface shape of the object. This information processing device uses the surface model to perform contact determination of contact between real objects and virtual objects, and combines images using the outline model.

The image display device described in Japanese Patent Application Publication No. 2015-007722 combines objects in a virtual world with images of the real world by adjusting at least one of focal distance of an image-capturing optical system, or digital zoom power, with respect to a virtual object, in order to maintain consistency in geometric size among real objects and virtual objects.

As AR technology and MR technology becomes commonplace, it is desirable for automatic shooting cameras to be able to automatically shoot images in which objects that are present in real space and objects that are present in virtual space are combined. However, there are cases in which inconsistency occurs in positional relations among real objects and virtual objects at the time of combining real images and virtual images, resulting in combined images being generated in which a real object and a virtual object are overlapped, or in which one of the real object and the virtual object is embedded in the other.

The technology disclosed in Japanese Patent Application Publication No. 2018-142273 is technology for implementing interaction from virtual objects in an MR system, and does not anticipate a situation in which a real object and a virtual object greatly overlap. Also, the technology disclosed in Japanese Patent Application Publication No. 2015-007722 is technology for solving inconsistency relating to apparent size of real objects and virtual objects, and does not solve inconsistency in positional relation and overlapping of objects. In this way, in a case of combining real objects and virtual objects by an automatic shooting camera, there is concern that the combined image will be an unnatural image, due to overlapping caused by inconsistency in positional relations among real objects and virtual objects in a space.

### SUMMARY OF THE INVENTION

The present invention provides an information processing device that is capable of obtaining images in which there is no inconsistency in positional relations among virtual objects and real objects, and the virtual objects and the real objects do not overlap.

A first aspect of the present invention is an information processing device including one or more processors and/or circuitry configured to: execute acquisition processing of acquiring a real image in which real space is image-captured, execute generating processing of generating, based on data of a virtual object placed in virtual space, a virtual image representing the virtual space in which the virtual object is placed, execute combining processing of combining the real image and the virtual image, and generating a combined image, and execute control processing in which, based on whether or not a real object included in the real image and the virtual object included in the virtual image overlap, framing control is performed to adjust positions of the real object and the virtual object in the combined image, wherein, in the combining processing, the real image that is image-captured based on the framing control and the virtual image that is generated based on the framing control are combined.

A second aspect of the present invention is an information processing device including one or more processors and/or circuitry configured to: execute acquisition processing of acquiring a real image in which real space is image-captured, execute generating processing of generating, based on data of a virtual object placed in virtual space, a virtual image representing the virtual space in which the virtual object is placed, execute control processing of, based on whether or not a real object included in the real image and the virtual object included in the virtual image overlap, controlling a first timing of acquiring the real image and a second timing for generating the virtual image, and execute combining processing of combining the real image acquired at the first timing and the virtual image generated at the second timing and generating a combined image.

Further features of the present invention will become apparent from the following description of exemplary embodiments with reference to the attached drawings.

### BRIEF DESCRIPTION OF THE DRAWINGS

FIG. 1 is a diagram illustrating a hardware configuration of an image-capturing device and a computing device;

FIG. 2 is an external view of the image-capturing device;

FIG. 3 is a diagram illustrating a configuration of an information processing unit according to a first embodiment;

FIG. 4 is a flowchart exemplifying image combining processing according to the first embodiment;

FIGS. 5A to 5C are diagrams for describing collision determination regarding collision of a real object and a virtual object;

FIGS. 6A to 6D are diagrams for describing framing control according to the first embodiment;

FIG. 7 is a diagram illustrating a hardware configuration of an image-capturing device according to a second embodiment;

FIG. 8 is a diagram illustrating a configuration of an information processing unit according to the second embodiment;

FIGS. 9A and 9B are diagrams for describing a coordinates system used for collision determination in the second embodiment;

FIG. 10 is a diagram illustrating a configuration of an image processing unit according to a third embodiment;

FIG. 11 is a flowchart exemplifying image combining processing according to the third embodiment;

FIGS. 12A to 12D are diagrams for describing collision determination processing according to the third embodiment;

FIG. 13 is a flowchart exemplifying image combining processing according to fourth and fifth embodiments;

FIGS. 14A and 14B are diagrams for describing framing control according to the fourth embodiment;

FIGS. 15A to 15C are diagrams for describing framing control according to the fifth embodiment;

FIG. 16 is a diagram illustrating a configuration of an information processing unit according to a sixth embodiment; and

FIG. 17 is a flowchart exemplifying image combining processing according to the sixth embodiment.

### DESCRIPTION OF THE EMBODIMENTS

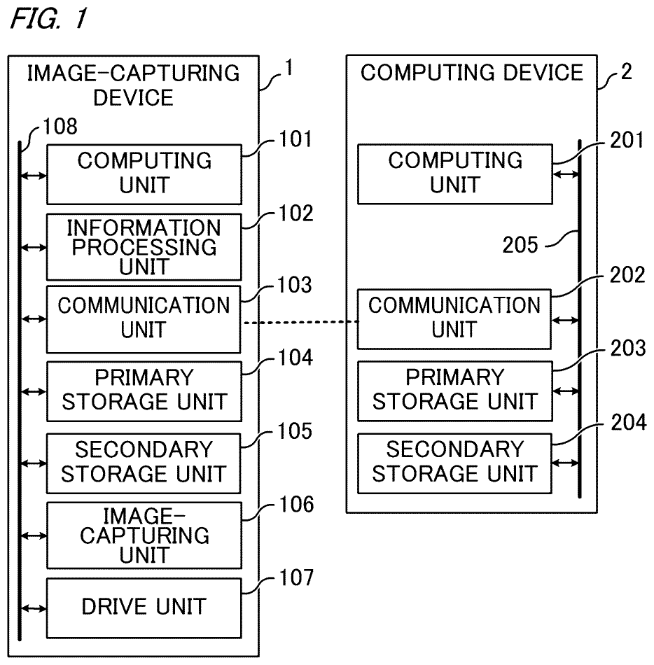

Embodiments of the present invention will be described below with reference to drawings. Configurations of an image-capturing device 1 and a computing device 2 that are common to each of the embodiments of the present invention will be described with reference to FIG. 1. A user uses the image-capturing device 1 serving as an information processing device according to the present invention, and acquires combined images, in which real images in which real space is image-captured by the image-capturing device 1, and virtual images representing virtual space in which virtual objects are placed, are combined. Data of virtual objects placed in the virtual space is transferred to the image-capturing device 1 from an external computing device 2 or the like, for example.

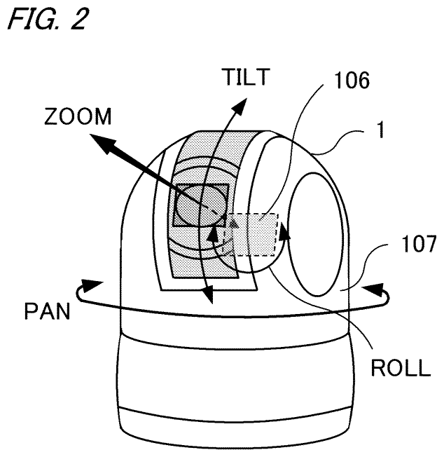

FIG. 1 is a diagram illustrating hardware configurations of the image-capturing device 1 and the computing device 2. FIG. 2 is an external view of the image-capturing device 1. In FIGS. 1 and 2, the same signs denote the same components. The image-capturing device 1 has a computing unit 101, an information processing unit 102, a communication unit 103, a primary storage unit 104, a secondary storage unit 105, an image-capturing unit 106, and a drive unit 107. The components of the image-capturing device 1 perform transmission and reception of data via a bus 108.

The computing unit 101 is a processor such as a central processing unit (CPU) or the like, for example, and controls the other components. The information processing unit 102 performs computing processing of image data that the image-capturing unit 106 acquires, computing processing of various types of evaluation values that the image-capturing unit 106 acquires, computing processing of data of the virtual object that the communication unit 103 acquires, and computing processing of data used for control of the drive unit 107.

The communication unit 103 is a communication interface for transmitting and receiving data and so forth of virtual objects to and from the computing device 2. The primary storage unit 104 is dynamic random-access memory (DRAM) for example, and temporarily stores data that the computing unit 101 and the information processing unit 102 use. The secondary storage unit 105 is flash memory, for example, and stores data that the computing unit 101 uses, and recorded images and so forth that the information processing unit 102 has processed and encoded.

The image-capturing unit 106 collects light from an object, performs imaging thereof, and converts the light into digital data. The drive unit 107 changes an optical system of the image-capturing unit 106. The drive unit 107 may, in addition to driving a zoom and an iris diaphragm, rotate an angle of view about at least one of a pan axis, a tilt axis, and a roll axis. Rotation about the pan axis and the tilt axis is performed by adjusting the angle of the entire optical system including an optical lens and an image-capturing element. Rotation about the roll axis is performed by adjusting the angle of the image-capturing element. Also, the image-capturing device 1 may be able to move in at least one direction of up-down, right-left, and forward-rearward.

Note that in a case in which the image-capturing device 1 is an automatic shooting camera, the drive unit 107 performs framing by adjusting the angle of the image-capturing element, but this is not restrictive. In a case in which the image-capturing device 1 is a device that is capable of moving and rotating, such as a drone for example, the drive unit 107 can perform framing by moving and rotating the device body itself. Also, in a case in which the image-capturing device 1 is equipped with externally-mounted machinery, like a driven camera platform such as a gimbal, the drive unit 107 can perform framing by controlling movement of the driven camera platform. Also, framing may be performed by trimming images that are shot.

Note that the information processing device according to the present invention is not limited to devices having the image-capturing unit 106 as with the image-capturing device 1. The information processing device may acquire real images in which real space is image-captured from an external device.

The computing device 2 has a computing unit 201, a communication unit 202, a primary storage unit 203, and a secondary storage unit 204. The components of the computing device 2 perform transmission and reception of data via a bus 205. The computing unit 201 is a processor such as a CPU or the like, for example, and controls the other components. The communication unit 202 is a communication interface for transmitting and receiving data and so forth of virtual objects to and from the image-capturing device 1. The primary storage unit 203 is DRAM for example, and temporarily stores data that the computing unit 201 uses. The secondary storage unit 204 is flash memory, for example, and stores data that the computing unit 201 uses.

The image-capturing device 1 and the computing device 2 operate collaboratively to generate combined images in which real images in which real space is image-captured, and virtual images representing virtual space in which virtual objects are placed, are combined. The image-capturing device 1 acquires real images including real objects by performing image-capturing of real space. Also, the image-capturing device 1 receives data of virtual objects from the computing device 2, and generates virtual images representing virtual space in which virtual objects are placed, on the basis of data of virtual objects that are received.

The image-capturing device 1 determines whether or not a real object included in a real image and a virtual object included in a virtual image overlap. Overlapping of a real object and a virtual object includes, for example, cases in which a real object and a virtual object are displayed superimposed, and cases in which one of the real object and the virtual object is embedded in the other. Overlapping of real objects and virtual objects will also be referred to as “collision” hereinafter.

The image-capturing device 1 determines whether or not real objects and virtual objects collide, and performs framing control on the basis of determination results. Framing control includes processing of controlling to adjust the positions of the real objects and virtual objects within the combined image, so as to fit within the combined image. Framing control may include processing of adjusting the positions of the real objects in real space, and processing of adjusting the positions of the virtual objects in the virtual space.

On the basis of the framing control, the image-capturing device 1 performs image-capturing of real images, generates virtual images, and so forth. The image-capturing device 1 combines real images that are image-captured on the basis of the framing control, and virtual images that are generated on the basis of framing control, and generates a combined image. Thus, the image-capturing device 1 can generate combined images in a state in which collision is avoided.

Note that the image-capturing device 1 may control shutter release timing on the basis of whether or not real objects and virtual objects collide. The shutter release timing includes a timing of image-capturing real images, and a timing of generating virtual images.

### First Embodiment

The first embodiment is an embodiment in which collision of a real object and a virtual object is determined, and a combined image is generated using a real image and a virtual image at a timing (shutter release timing) at which the real object and the virtual object do not collide (do not overlap).

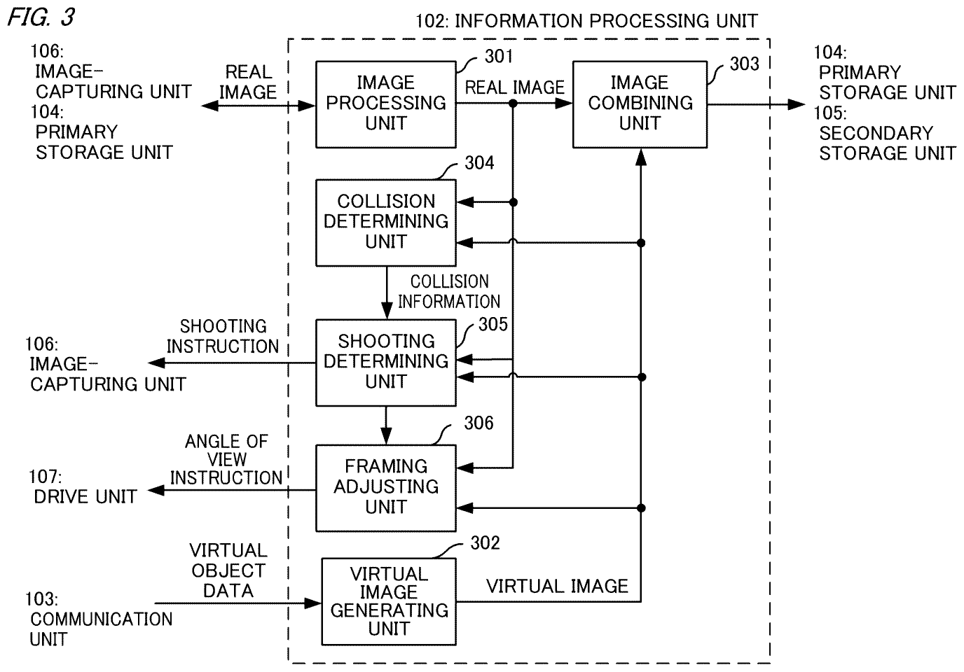

FIG. 3 is a diagram illustrating a configuration of the information processing unit 102 according to the first embodiment. The information processing unit 102 has an image processing unit 301, a virtual image generating unit 302, an image combining unit 303, a collision determining unit 304, a shooting determining unit 305, and a framing adjusting unit 306. The components of the information processing unit 102 transmit and receive data via the bus 108 of the image-capturing device 1.

The image processing unit 301 acquires data of real images in which real objects are shot (hereinafter referred to as “real image”), input from the image-capturing unit 106 or the primary storage unit 104. The image processing unit 301 performs known image processing, such as developing processing and so forth, with respect to the real image that is acquired. The real image that is subjected to image processing is output to the primary storage unit 104 or the image combining unit 303.

The virtual image generating unit 302 generates virtual images in which virtual objects are placed, on the basis of data of virtual objects input from the communication unit 103. Data of virtual objects includes, for example, coordinate information of a representative point of a virtual object (three-dimensional global coordinate data), and coordination information of points making up the virtual object (local coordinate data of which the representative point is a reference). Also, the data of virtual objects includes color, texture, transparency, property information of contact/transmission, and physical property information such as mass and so forth, of virtual objects. The property information of contact/transmission is information regarding whether coming into contact with the virtual object will affect the virtual object, such as moving, deforming, or the like, or will be transmitted therethrough without affecting the virtual object.

The virtual image generating unit 302 generates (renders) virtual images to serve as results of shooting virtual objects using a virtual camera in virtual space (hereinafter referred to as “virtual camera”) by a known technique using data of the virtual objects. The virtual image generating unit 302 also matches shooting parameters, such as the shooting angle of view or the like of the virtual camera, with the shooting parameters of real images, taking into consideration combining with the real images.

The clock time in the virtual space is preferably synchronized with the clock time in real space. The timing of transmitting data regarding virtual objects from the communication unit 202 to the communication unit 103 is also preferably synchronized with the timing of acquiring real images, but may be asynchronous.

The image combining unit 303 superimposes virtual images input from the virtual image generating unit 302 onto real images input from the image processing unit 301 by a known technique, and generates data of combined images (hereinafter referred to as “combined image”). The combined images that are generated are output to the primary storage unit 104 or the secondary storage unit 105. The combined images may be subjected to known encoding processing such as JPEG or the like for recording, and thereafter be output to the primary storage unit 104 or the secondary storage unit 105.

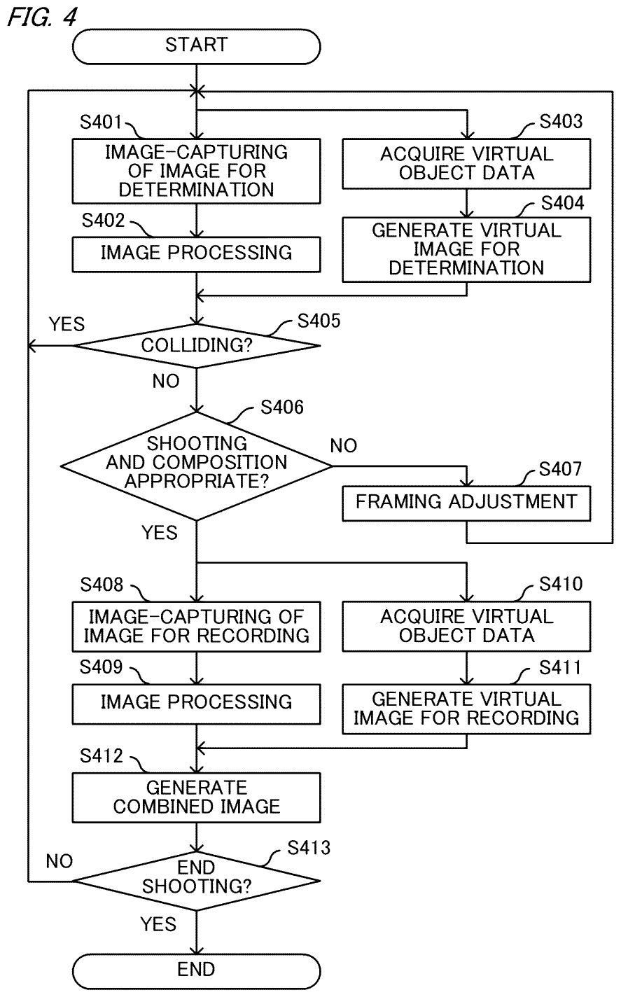

The collision determining unit 304 performs determination regarding collision between objects in real images input from the image processing unit 301 (real object) and objects in virtual images input from the virtual image generating unit 302 (virtual object). The collision determining unit 304 outputs determination results to the shooting determining unit 305 as collision information. Determination processing regarding collisions will be described in detail with reference to a flowchart in FIG. 4, which will be described later.

The shooting determining unit 305 decides shooting timing on the basis of the collision information, positions of real objects in the real images input from the image processing unit 301 (two-dimensional image coordinates), and positions of virtual objects in the virtual images input from the virtual image generating unit 302 (two-dimensional image coordinates). The shooting determining unit 305 gives shooting instructions to the image-capturing unit 106 on the basis of the shooting timing that is decided. Shooting determining processing will be described in detail with reference to the flowchart in FIG. 4, which will be described later.

The framing adjusting unit 306 decides an adjustment amount of a shooting angle of view on the basis of the positions of real objects in the real images that are input from the image processing unit 301, the positions of virtual objects in the virtual images that are input from the virtual image generating unit 302, and the shooting determination results from the shooting determining unit 305. The framing adjusting unit 306 instructs the drive unit 107 to adjust the angle of view on the basis of the adjustment amount of the shooting angle of view that is decided. Framing adjustment processing will be described in detail with reference to the flowchart in FIG. 4, which will be described later.

FIG. 4 is a flowchart exemplifying image combining processing according to the first embodiment. The image combining processing is processing of combining a real image in which real space is image-captured and a virtual image representing virtual space in which a virtual object is placed, so as to generate a combined image. In the image combining processing, the components illustrated in FIGS. 1 and 3 are controlled in accordance with settings of parameters and operation instructions by the computing unit 101.

In step S401, the image-capturing unit 106 performs image-capturing processing for acquiring a real image for collision determination. The image-capturing unit 106 performs image-capturing processing using frame synchronizing signals used in moving images. Note that the image-capturing unit 106 may directly receive instructions from the computing unit 101 and perform image-capturing processing. Also, the real image may be subjected to pixel addition or pixel decimation and be read out, for a high-speed cycle of the collision determination processing.

In step S402, the image processing unit 301 of the information processing unit 102 performs image processing for collision determination, with respect to the real image for collision determination acquired in the image-capturing processing in step S401. The image processing unit 301 may simplify the image processing as compared to when recording the real image, for a high-speed cycle of the collision determination processing.

In parallel with step S401 and step S402, the virtual image generating unit 302 acquires data of the virtual object from the communication unit 202 of the computing device 2, via the communication unit 103, in step S403. In step S404, the virtual image generating unit 302 generates a virtual image for collision determination on the basis of the data of the virtual object that is acquired.

The communication unit 103 issues requests to the communication unit 202 at a predetermined cycle, and the communication unit 202 transmits the data of the virtual object that is present in the virtual space to the communication unit 103, in response to each of the requests. The virtual image generating unit 302 extracts, from the data of the virtual object received by the communication unit 103, data of the virtual object that is present in the shooting angle of view of the real image acquired in S401, and generates a virtual image on the basis of the data of the virtual object that is extracted. The virtual image generating unit 302 may simplify the virtual image generating processing as compared to when recording the virtual image, for a high-speed cycle of the collision determination processing.

In step S405, the collision determining unit 304 uses the real image and virtual image for collision determination, acquired in step S401 to step S404, to determine whether or not the real object in the real image and the virtual object in the virtual image are colliding. That is to say, the collision determining unit 304 determines whether or not the real object included in the real image and the virtual object included in the virtual image are overlapping in the two-dimensional plane of the combined image in which the real image and the virtual image are combined.

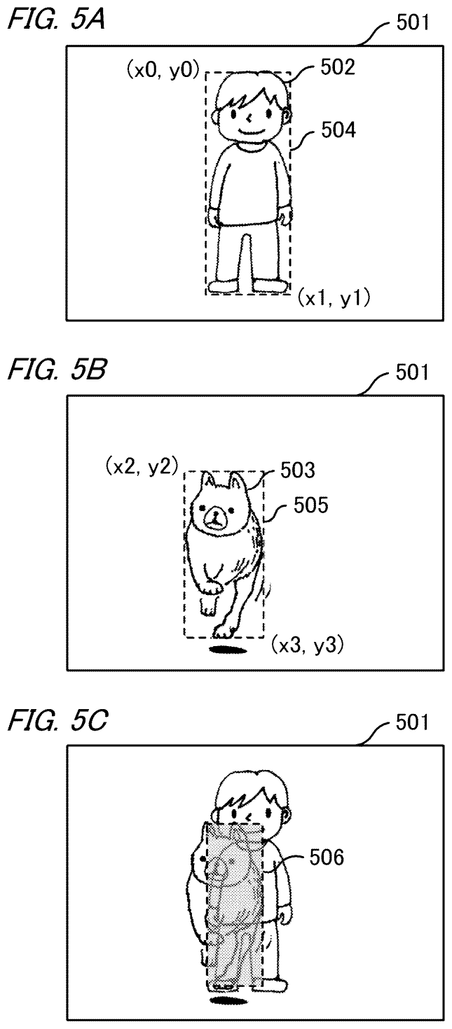

Collision determination of a real object and a virtual object will be described with reference to FIGS. 5A to 5C. In the first embodiment, the collision determining unit 304 determines whether or not the real object and the virtual object are colliding from conditions regarding two-dimensional coordinates. FIG. 5A illustrates a real image, FIG. 5B illustrates a virtual image, and FIG. 5C illustrates a combined image in which the real image and the virtual image have been combined.

The real image in FIG. 5A includes a real object 502 within an angle of view 501. A real object region 504 is a rectangular region encompassing the real object 502, and can be found by known object detection technology. The real object region 504 is expressed by coordinates (x0, y0) and coordinates (x1, y1) of two vertices of a diagonal line.

The virtual image in FIG. 5B includes a virtual object 503 within the angle of view 501. A virtual object region 505 is a rectangular region encompassing the virtual object 503, and can be found by known object detection technology. The virtual object region 505 is expressed by coordinates (x2, y2) and coordinates (x3, y3) of two vertices of a diagonal line.

In the combined image in FIG. 5C, the real object 502 and the virtual object 503 are overlapped. The collision determining unit 304 determines that the real object and the virtual object are colliding (overlapped) in a case in which there is a region 506 where the real object region 504 and the virtual object region 505 overlap. Whether or not there is the region 506 where the real object region 504 and the virtual object region 505 overlap can be determined by a known conditional expression.

In step S405, in a case in which determination is made that the real object and the virtual object are colliding, the processing returns to step S401 and step S403. In a case in which the real object and the virtual object overlap, the image-capturing device 1 does not combine the real image and the virtual image, but rather repeats processing of acquiring the real image for collision determination and generating the virtual image for collision determination, until determination is made that the real object and the virtual object are not colliding. In a case in which determination is made that the real object and the virtual object are not colliding, the processing advances to step S406.

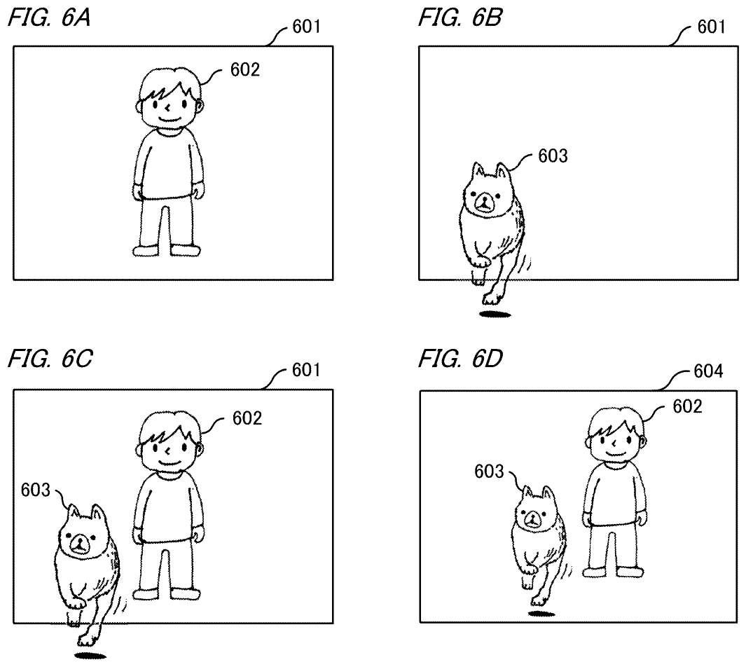

In step S406, the shooting determining unit 305 determines whether or not shooting can be performed of the real image for generating a combined image for recording. The shooting determining unit 305 can determine whether or not shooting can be performed, in accordance with whether or not shooting is appropriate, and whether or not a shooting composition is appropriate, for example. Determination of whether or not shooting can be performed, and framing control, will be described with reference to FIGS. 6A to 6D.

FIG. 6A illustrates a real image, FIG. 6B illustrates a virtual image, FIG. 6C illustrates a combined image in which the real image and the virtual image are combined, and FIG. 6D illustrates a combined image in which the real image and the virtual image are combined with the shooting angle of view having been changed. The real image in FIG. 6A includes a real object 602 within an angle of view 601. The virtual image in FIG. 6B includes a virtual object 603 within the angle of view 601. FIG. 6C illustrates a combined image at the angle of view 601. FIG. 6D illustrates a combined image at an angle of view 604 that has been adjusted by framing control.

In step S406, the shooting determining unit 305 determines, for example, (a) whether or not shooting is appropriate, and (b) whether or not the shooting composition is appropriate. In a case in which both determination results thereof are determined to be appropriate and that shooting can be performed, the processing advances to step S408 and step S410. In a case in which determination is made that the determination results of one of determination conditions (a) and (b) is inappropriate and that shooting is not performed, the processing advances to step S407.

The (a) whether or not shooting is appropriate is determined by whether or not the determination conditions such as the following are satisfied, for example.
(a1) The real object and the virtual object are facing frontward.
(a2) The face of the real object (person) is in focus.
(a3) The eyes of the real object (person) are not closed.
Determination of whether or not the determination conditions of (a1) to (a3) are satisfied can be realized by known technology.

In a case in which all of the determination conditions (a1), (a2), and (a3) are satisfied, the shooting determining unit 305 determines that shooting is appropriate. Note that determination conditions for determining whether or not shooting is appropriate may include other conditions realized by known technology, such as whether the face of the real object (person) is smiling, which can be realized by smile detection processing, or the like. Also, the shooting determining unit 305 may determine that shooting is appropriate in a case in which at least one of the determination conditions (a1) to (a3) is satisfied.

The (b) whether or not the shooting composition is appropriate is determined by whether the determination conditions such as the following are satisfied, for example.
(b1) The real object and the virtual object are detected in their entirety.
(b2) The size of the real object and the virtual object (the area of the regions thereof) is larger than a predetermined threshold value.
(b3) (A region including) the real object and the virtual object is present at the middle of the angle of view.
Determination of whether or not the determination conditions of (b1) to (b3) are satisfied can be realized by known technology.

In a case in which all of the determination conditions (b1), (b2), and (b3) are satisfied, the shooting determining unit 305 determines that the shooting composition is appropriate. Note that determination conditions for determining whether or not the shooting is appropriate may include other conditions besides the determination conditions (b1) to (b3). Also, the shooting determining unit 305 may determine that the shooting composition is appropriate in a case in which at least one of the determination conditions (b1) to (b3) is satisfied.

For example, the entirety of the real object 602 illustrated in FIG. 6A is detected, but the entirety of the virtual object 603 illustrated in FIG. 6B is not detected, since part (a leg of the dog) is outside of the angle of view 601. Also, in FIG. 6C, the region including the real object 602 and the virtual object 603 is not at the middle of the angle of view 601. Accordingly, in the examples of FIGS. 6A to 6C, determination is made that the shooting composition of the real image and the virtual image is not appropriate.

In step S407, the framing adjusting unit 306 adjusts the framing. Specifically, the framing adjusting unit 306 generates driving information for adjusting the framing, and transmits the driving information that is generated to the drive unit 107. The driving information includes, for example, driving parameters for zooming, driving parameters for the iris (diaphragm), rotation parameters regarding the pan axis, the tilt axis, and the roll axis, and so forth. Such driving information is found by known computation methods.

The framing adjusting unit 306 generates driving information such that the following control conditions (c1), (c2), and (c3) are satisfied.
(c1) The real object and the virtual object are detected in their entirety.
(c2) The size of the real object and the virtual object (the area of the regions thereof) is larger than a predetermined threshold value.
(c3) (A region including) the real object and the virtual object is at the middle of the angle of view.

In the example in FIG. 6C, the framing adjusting unit 306 adjusts the zoom to the wide-angle side such that the entirety of the virtual object 603 is detected within the angle of view 601. Also, the framing adjusting unit 306 adjusts the pan axis by rotating to the left, such that the real object 602 and the virtual object 603 are situated at the middle of the angle of view 601, and fit within the combined image. The framing adjusting unit 306 generates driving information such that the control conditions (c1) to (c3) are satisfied, which are transmitted to the drive unit 107. The drive unit 107 adjusts the framing in accordance with the driving information, and thus can perform framing control to obtain the appropriate shooting composition illustrated in FIG. 6D. Note that the framing adjusting unit 306 may gradually adjust the framing by repeating the processing of steps S401 to S407 with respect to a plurality of frames.

In step S408, the image-capturing unit 106 performs image-capturing processing for acquiring a real image for recording. In step S409, the image processing unit 301 of the information processing unit 102 performs image processing with respect to the real image for recording that is acquired in the image-capturing processing of step S408.

Parallel to step S408 and step S409, in step S410 the virtual image generating unit 302 acquires data of the virtual object from the communication unit 202 of the computing device 2, via the communication unit 103. In step S411, the virtual image generating unit 302 generates a virtual image for recording on the basis of the data of the virtual object that is acquired.

The communication unit 103 issues a request to the communication unit 202 at the timing of step S408, and the communication unit 202 transmits data of the virtual object that is present in the virtual space to the communication unit 103. The virtual image generating unit 302 extracts the data of the virtual object present in the shooting angle of view of the real image acquired in step S408, from the data of the virtual object received by the communication unit 103, and generates a virtual image on the basis of the data of the virtual object that is extracted.

In step S412, the image combining unit 303 combines the real image obtained in step S409 and the virtual image obtained in step S411, thereby generating a combined image for recording. The image combining unit 303 can perform combining of the real image and the virtual image by alpha blending, for example. In the example in FIG. 6D, there is no overlapping of the real object and the virtual object, and accordingly the blend rate of the virtual object can be set to 1.0 in the region of the virtual object, and to 0.0 in regions other than the virtual object.

In step S413, the computing unit 101 determines whether or not to end shooting. The computing unit 101 ends shooting by accepting an instruction from the user to end shooting, for example. In a case of not ending shooting, the processing returns to step S401 and step S403. The processing of steps S401 to S412 is repeatedly executed until there is an instruction to end shooting.

According to the first embodiment described above, the image-capturing device 1 can generate a combined image in a state in which the real object and the virtual object are not colliding, and also in a state in which framing is adjusted. Accordingly, the image-capturing device 1 can generate a combined image in a suitable state of the objects (real object and virtual object), at a suitable angle of view.

### Second Embodiment

A second embodiment differs from the first embodiment with respect to the collision determination method regarding collision of a real object and a virtual object. In the first embodiment, the collision determining unit 304 determines collision by planar overlapping of the real object and the virtual object in the two-dimensional plane of the combined image. Conversely, in the second embodiment, the collision determining unit 304 determines whether or not the real object and the virtual object will collide (will overlap) in three-dimensional space in which real space and virtual space are merged.

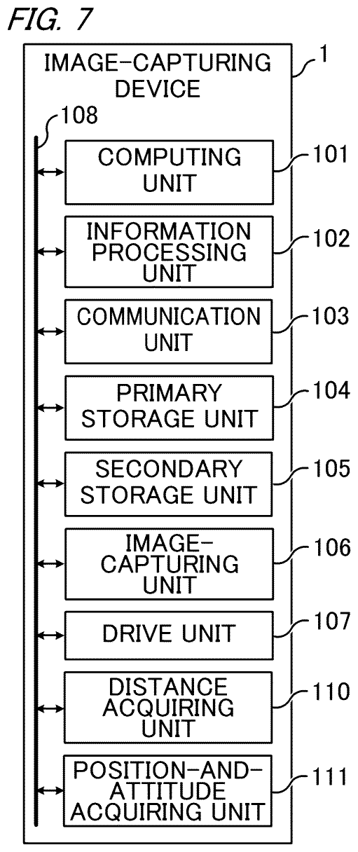

FIG. 7 is a diagram illustrating a hardware configuration of the image-capturing device 1 according to the second embodiment. The image-capturing device 1 according to the second embodiment has, in addition to the configuration illustrated in FIG. 1, a distance acquiring unit 110 and a position-and-attitude acquiring unit 111. Configurations that are the same as those in FIG. 1 are denoted by the same signs, and detailed description will be omitted. Also, the computing device 2 according to the second embodiment is the same as the configuration illustrated in FIG. 1, and accordingly detailed description thereof will be omitted.

The distance acquiring unit 110 is a sensor that acquires distance from the image-capturing device 1 to an object that is a real object. Examples of the distance acquiring unit 110 include, for example, a phase-difference sensor that detects a phase difference of an incident ray from the object and measures the distance, a distance sensor that measures the distance by emitting a ray toward the object and measuring the time until reflected light returns, or a like type of sensor. The distance acquiring unit 110 may use the same sensor as the image-capturing unit 106 to acquire information of distance.

The position-and-attitude acquiring unit 111 is a sensor that acquires information of the position and attitude of the image-capturing device 1. The position-and-attitude acquiring unit 111 acquires position information by, for example, a sensor for a positioning system that uses satellites, and can acquire attitude information by an acceleration sensor.

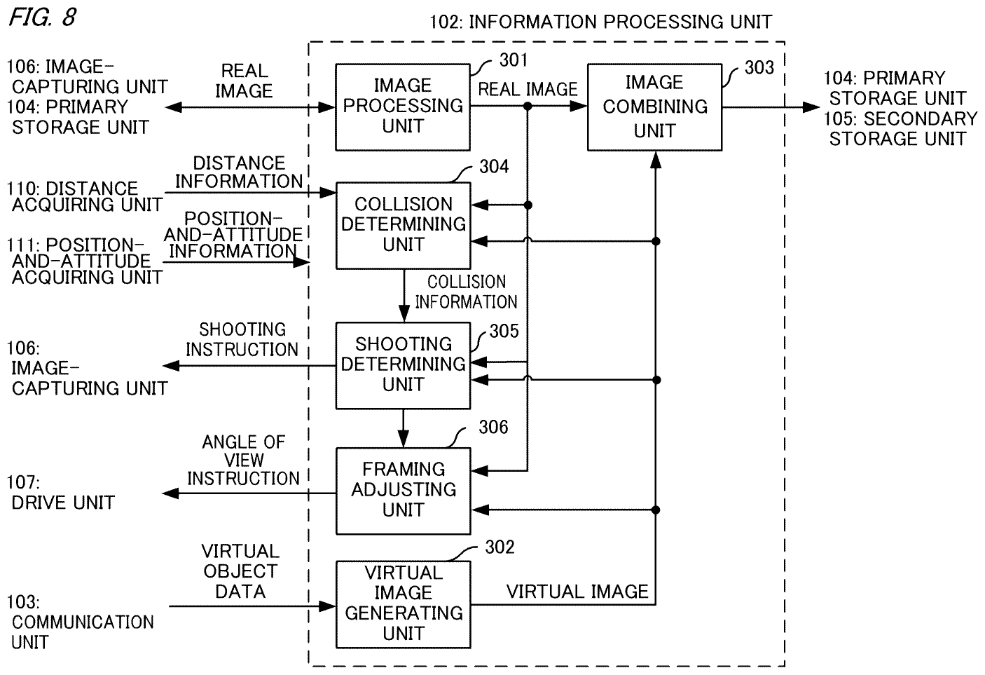

FIG. 8 is a diagram illustrating a configuration of the information processing unit 102 according to the second embodiment. In the information processing unit 102 according to the second embodiment, the processing performed by the collision determining unit 304 differs from the processing described in FIG. 3. In the second embodiment, the collision determining unit 304 acquires distance information from the distance acquiring unit 110, and acquires position information and attitude information of the image-capturing device 1 from the position-and-attitude acquiring unit 111. The distance information is the distance from the image-capturing device 1 to the object. The collision determining unit 304 executes collision determination processing by a method that differs from the first embodiment, using the distance information and position-and-attitude information.

The image combining processing in the second embodiment is the same as the image combining processing in the first embodiment, except for the processing in step S405 shown in FIG. 4. The method for determining whether or not the real object and the virtual object are colliding (are overlapping) in step S405 of the second embodiment will be described below.

In the collision determination processing of the second embodiment, the collision determining unit 304 uses the distance information of the real object and the virtual object, finds coordinates of points making up the real object and the virtual object in three-dimensional space, and determines whether or not these objects are colliding.

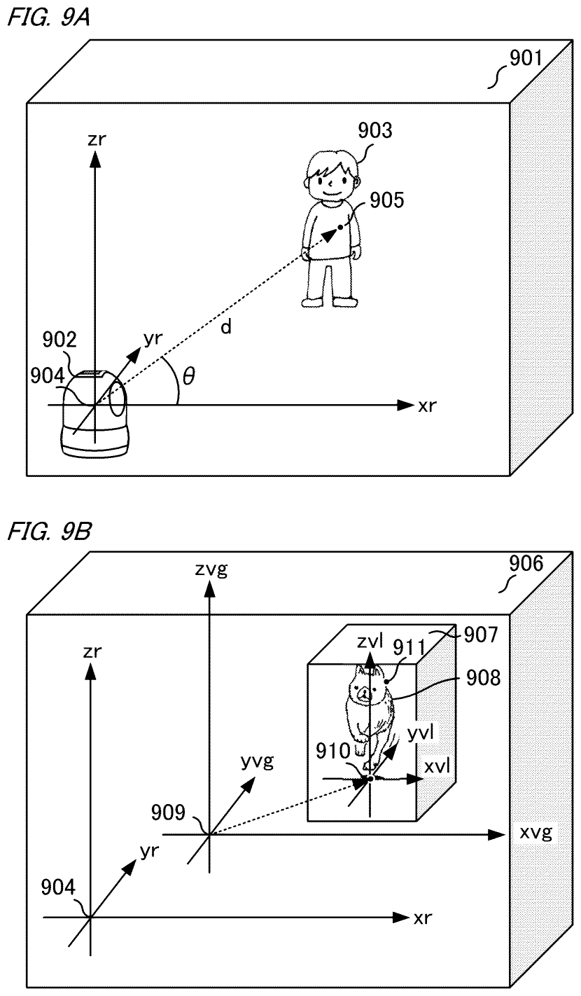

FIGS. 9A and 9B are diagrams for describing coordinates systems of the real object and the virtual object to be used for collision determination. In the collision determination processing according to the second embodiment, three coordinate systems of a real space global coordinate system, a virtual space global coordinate system, and a virtual space local coordinate system are defined.

Coordinates of the virtual object in the three-dimensional space where real space and virtual space are merged can be acquired on the basis of the coordinates of the real object in the three-dimensional space. That is to say, coordinates of the virtual object expressed in terms of the virtual space local coordinate system can be converted into coordinates in the real space global coordinate system on the basis of coordinates of the real object expressed in terms of the real space global coordinate system.

First, the collision determining unit 304 finds three-dimensional coordinates of points that make up a real object 903. A real space global coordinate system 901 is a coordinate system for expressing coordinates of the real object 903. The real space global coordinate system 901 is defined by an origin 904 and an xr axis, a yr axis, and a zr axis. The origin 904 can be set as an optical center of the image-capturing device 1 (image-capturing device 902) that is present in the real space. The real object 903 is an object that is present in the real space. A point 905 is a point making up the real object 903.

The collision determining unit 304 can acquire the coordinates of the real object 903 in the three-dimensional space on the basis of the position and attitude of the image-capturing device 1 performing image-capturing of the real space, and the distance from the image-capturing device 1 to the real object 903. Specifically, the position-and-attitude acquiring unit 111 of the image-capturing device 1 acquires coordinates of the optical center (origin 904) in the real space global coordinate system 901 and an object azimuthal orientation θ. Also, the distance acquiring unit 110 of the image-capturing device 1 acquires an object distance d. The collision determining unit 304 finds the three-dimensional coordinates of the point 905 in the real space global coordinate system 901 on the basis of coordinates of the optical center (coordinates of origin 904), the object azimuthal orientation θ of the point 905 with respect to the origin 904, and the object distance d from the origin 904 to the point 905.

The collision determining unit 304 finds coordinates relating to points making up the real object 903, or part of these points, in the same way as with the point 905. The points making up the real object 903 are points in the three-dimensional space image-captured by the image-capturing device 1, for example, and are a plurality of representative points on the surface of the real object 903. The collision determining unit 304 stores the coordinates found for the plurality of points making up the real object 903 in the primary storage unit 104.

Next, the collision determining unit 304 finds coordinates of points making up a virtual object 908. A virtual space global coordinate system 906 is defined by an origin 909, and an xvg axis, a yvg axis, and a zvg axis. The virtual space global coordinate system 906 is a coordinate system that is uniquely set by virtual space that the computing device 2 has. The virtual space global coordinate system 906 may be the same as the real space global coordinate system, or may be a different coordinate system that corresponds in a one-on-one manner.

A virtual space local coordinate system 907 is a coordinate system defined by an origin 910, and an xvl axis, a yvl axis, and a zvl axis, and is included in the virtual space global coordinate system 906. The virtual object 908 is an object of the virtual object that is present in the virtual space global coordinate system 906. The virtual space local coordinate system 907 is used to express individual forms of each of virtual objects that are present in the virtual space. The virtual space local coordinate system 907 moves as the virtual object 908 moves. A plurality of the virtual space local coordinate system 907 may be present in the virtual space global coordinate system 906. A point 911 is a point making up the virtual object 908.

The image-capturing device 1 finds the real space global coordinates of the point 911 from a relation between the real space global coordinate system 901 and the virtual space global coordinate system 906, the real space global coordinates of the origin 910 of the virtual space local coordinate system 907, and the virtual space local coordinates of the point 911. In this way, the image-capturing device 1 can acquire coordinates of virtual objects in three-dimensional space on the basis of coordinates of real objects in three-dimensional space.

The collision determining unit 304 finds coordinates relating to points making up the virtual object 908, or part of these points, in the same way as with the point 911. The points making up the virtual object 908 can be vertices of polygons in a case in which the virtual object is made up of polygons, and can be a representative point in each voxel in a case in which the virtual object is made up of voxels. The collision determining unit 304 stores the coordinates found for the plurality of points making up the virtual object 908 in the primary storage unit 104.

The collision determining unit 304 determines whether or not a plane formed of the points making up the virtual object 908 and adjacent points intersects in three-dimensional space with a plane formed of the points making up the real object and adjacent points. Whether or not the two planes intersect in three-dimensional space can be determined by known techniques.

In step S405 in FIG. 4, the collision determining unit 304 determines that the virtual object and the real object are colliding in a case in which the plane formed by points making up the virtual object and the plane formed by points making up the real object intersect. The collision determining unit 304 determines that the virtual object and the real object are not colliding in a case in which the plane formed by points making up the virtual object and the plane formed by points making up the real object do not intersect. The image combining processing of step S406 in FIG. 4 and thereafter is continued in accordance with the collision determination results from the collision determining unit 304.

According to the second embodiment described above, the image-capturing device 1 can determine collision of the real object and the virtual object in three-dimensional space in which real space and virtual space are merged, rather than planar collision determination in the combined image. The image-capturing device 1 can determine inconsistencies on the positional relation of objects in the three-dimensional space more accurately, and can generate a combined image in which there is no collision between the virtual object and the real object in the three-dimensional space. Note that in the following third through sixth embodiments, the collision determining unit 304 may determine whether or not the real object and the virtual object are colliding, using either configuration and method of the first embodiment and the second embodiment.

### Third Embodiment

A third embodiment is an embodiment in which a combined image is generated at a timing at which the real object and the virtual object will not collide (will not overlap), by predicting the position of the virtual object in the future. The computing device 2 holds data of the virtual space and data of the virtual object for each clock time. What sort of behavior the virtual object will exhibit in the future is set in advance. That is to say, the data of the virtual object includes movement information such as position, speed, orientation, shape, size, and so forth, of the virtual object, for each clock time. The image-capturing device 1 acquires data of the virtual object, up to after a predetermined amount of time in the future, from the computing device 2, and thereby can predict the position of the virtual object after a predetermined amount of time.

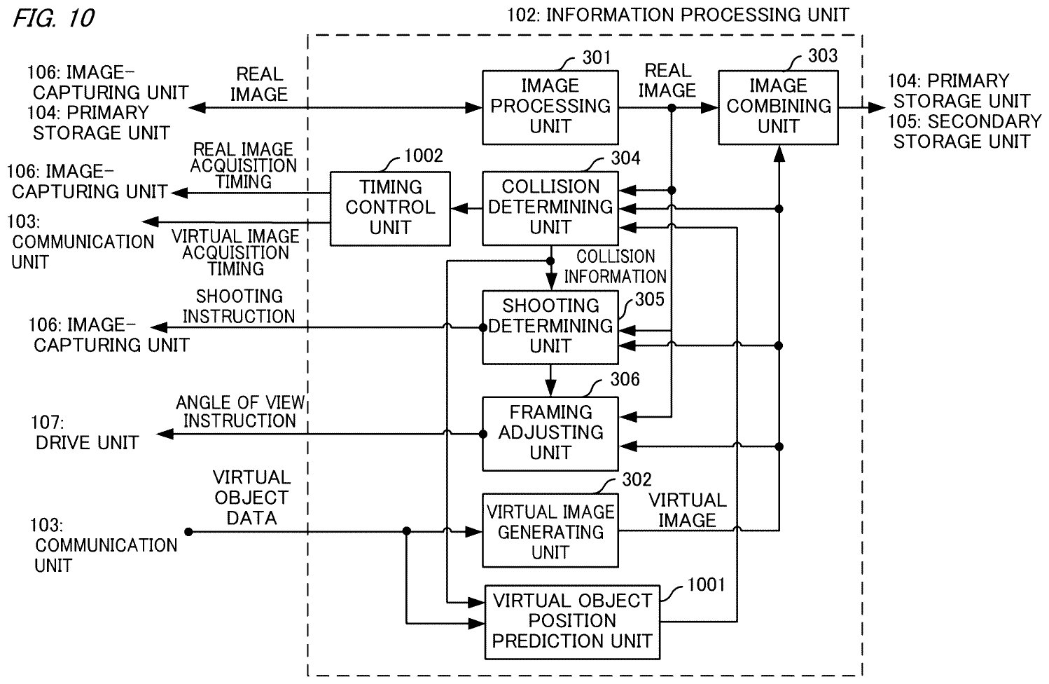

FIG. 10 is a diagram illustrating a configuration of the information processing unit 102 according to the third embodiment. The information processing unit 102 according to the third embodiment has, in addition to the configuration illustrated in FIG. 3, a virtual object position prediction unit 1001 and a timing control unit 1002. Configurations that are the same as those in FIG. 3 are denoted by the same signs, and repetitive description will be omitted.

The virtual object position prediction unit 1001 predicts the position of the virtual object in the future, and outputs information of the position of the virtual object that is predicted to the collision determining unit 304. Accordingly, the collision determining unit 304 can determine whether or not the real object and the virtual object are colliding in the combined image of the current real image and the virtual image in the future.

The timing control unit 1002 instructs the image-capturing unit 106 regarding timing for acquiring (image-capturing) the real image, on the basis of whether or not the real object and the virtual object are colliding (overlapped). Also, the timing control unit 1002 instructs the computing device 2, via the communication unit 103, regarding timing for acquiring (generating) the virtual image, on the basis of whether or not the real object and the virtual object are colliding (overlapped). Accordingly, the timing control unit 1002 can acquire the real image and the virtual image at different timings.

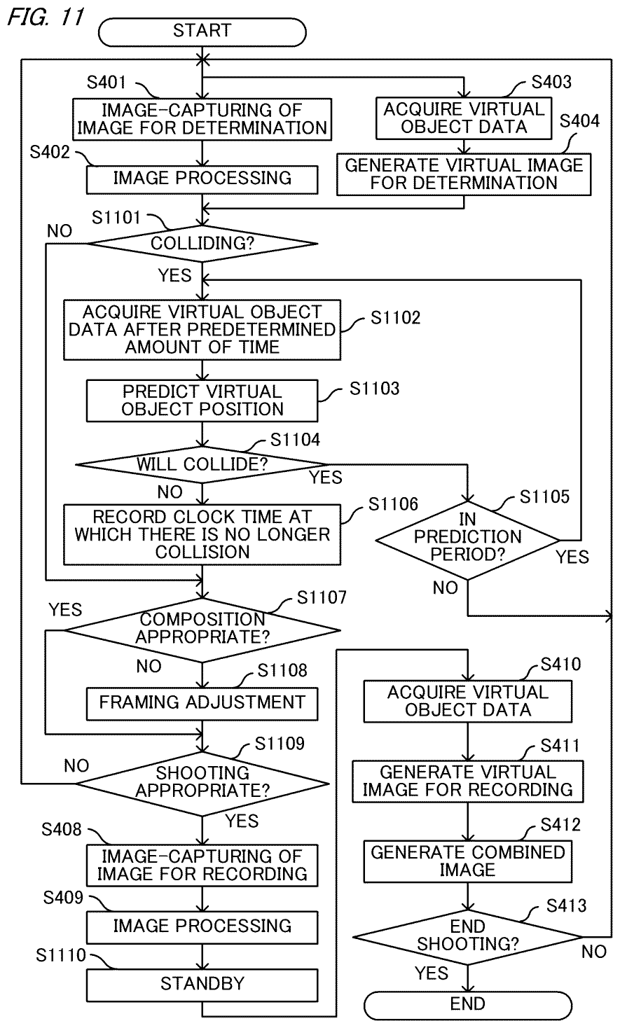

FIG. 11 is a flowchart exemplifying image combining processing according to the third embodiment. The processing of steps S401 to S404, S408, S409, and S410 to S413 is the same as the processing of the first embodiment shown in FIG. 4, and accordingly repetitive description will be omitted. Processing of the steps S1101 to S1109, and S1110, which differ from the first embodiment, will be described below.

In step S1101, the collision determining unit 304 determines whether or not the real object included in the real image and the virtual object included in the virtual image are overlapped in the combined image obtained by combining the real image and the virtual image.

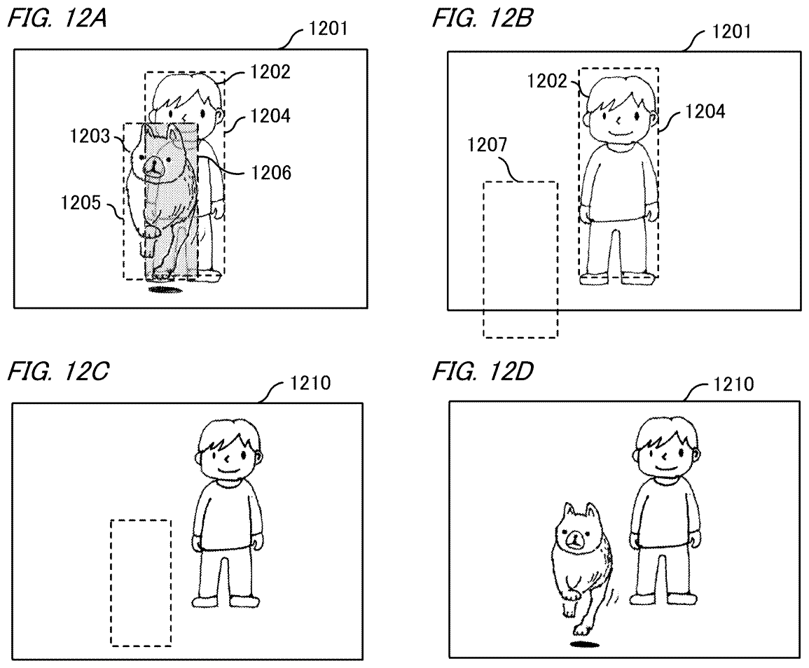

The collision determination processing in step S1101 will be described with reference to FIGS. 12A to 12D. FIG. 12A is a diagram illustrating a combined image in which the real image and the virtual image have been combined at the timing of step S1101. The combined image in FIG. 12A includes, in an angle of view 1201, a real object 1202, and a virtual object 1203 in the virtual image that is generated at approximately the same timing as the real image that is image-captured in step S401. A real object region 1204 is a rectangular region encompassing the real object 1202. A virtual object region 1205 is a rectangular region encompassing the virtual object 1203. A region 1206 indicates overlapping of the real object region 1204 and the virtual object region 1205.

In the combined image in FIG. 12A, the real object 1202 and the virtual object 1203 are overlapping. In a case in which there is a region 1206 in which the real object region 1204 and the virtual object region 1205 are overlapping, the collision determining unit 304 determines that the real object and the virtual object are colliding (overlapping). In a case in which the real object and the virtual object are colliding, the processing advances to step S1102. In a case in which the real object and the virtual object are not colliding, the processing advances to step S1107.

In step S1102, the virtual object position prediction unit 1001 acquires movement information of the virtual object from the computing device 2 via the communication unit 103. The computing device 2 holds position information of the virtual object, and performs control to move the position of the virtual object in the virtual space on the basis of the position information of the virtual object. The virtual object position prediction unit 1001 can acquire the movement information of the virtual object that has been determined to be colliding with the real object from the computing device 2, and predict movement of the virtual object in the future. The movement information includes information such as position, speed, orientation, shape, size, and so forth, of the virtual object (points and plan making up the virtual object) at each clock time in the three-dimensional space. The virtual object position prediction unit 1001 can acquire virtual object data after a predetermined amount of time using the movement information. The predetermined amount of time may be decided on the basis of speed of the virtual object, and so forth, for example.

In step S1103, the virtual object position prediction unit 1001 predicts the position of the virtual object after the predetermined amount of time, using data of the virtual object after the predetermined amount of time, acquired in step S1102. In a case in which the real object included in the real image and the virtual object included in the virtual image overlap, the virtual object position prediction unit 1001 predicts the position of the virtual object after the predetermined amount of time.

In step S1104, the collision determining unit 304 determines whether or not the real object included in the real image, and the virtual object placed at the position predicted by the virtual object position prediction unit 1001 after the predetermined amount of time in the virtual image, will collide (will overlap). In a case of determining that they will collide, the processing advances to step S1105. In a case of determining that they will not collide, the processing advances to step S1106.

A specific example of the processing in step S1104 will be described with reference to FIG. 12B. FIG. 12B is a diagram illustrating a combined image in which the real image that is image-captured in step S401, and the virtual image at a virtual object region 1207 that is the position of the virtual object after the predetermined amount of time, are combined. The real object region 1204 illustrated in the angle of view 1201 of the combined image in FIG. 12B is a rectangular region encompassing the real object 1202. The virtual object region 1207 is a rectangular region indicating the position of the virtual object after the predetermined amount of time. In a case in which the real object region 1204 and the virtual object region 1207 are not overlapping, the collision determining unit 304 determines that the real object and the virtual object after the predetermined amount of time will not collide (will not overlap).

In step S1105, the collision determining unit 304 determines whether or not the clock time (timing) after the predetermined amount of time is within a prediction period. The prediction period is period elapsed from the clock time at which the real image for determination is acquired in step S401, and is set in advance. In a case in which the real object and the virtual object are no longer colliding (no longer overlapping) during the prediction period, the combined image for recording is generated. Conversely, in a case in which the collision between the real object and the virtual object is not resolved (the real object and the virtual object are still overlapped) even after the prediction period elapses from the clock time of acquiring the real image, the combined image for recording is not generated.

In a case in which the clock time after the predetermined amount of time is within the prediction period, the processing returns to step S1102. The virtual object position prediction unit 1001 newly acquires virtual object data after the next predetermined amount of time, and predicts the position of the virtual object after the next predetermined amount of time. The next predetermined amount of time is set to be a longer time than the current predetermined amount of time. The virtual object position prediction unit 1001 repeats the processing of step S1102 and step S1103 until there is no more collision between the real object and the virtual object at the predicted position within the prediction period.

In a case in which the clock time after the predetermined amount of time is not within the prediction period, the processing returns to step S401 and step S403. Collision between the real object included in the real image that is image-captured in step S401 and the virtual object within the prediction period is not avoided, and accordingly the image-capturing unit 106 newly acquires a real image for collision determination, and the virtual image generating unit 302 newly generates a virtual image for collision determination.

In step S1106, the collision determining unit 304 specifies the clock time at which the virtual object will no longer collide with the real object, on the basis of the determination in step S1104, as the timing for generating the virtual image, and records in the primary storage unit 104 or the like.

In step S1107, the shooting determining unit 305 determines whether or not shooting can be performed of the real image for generating the combined image for recording, on the basis of whether or not the shooting composition is appropriate. The determination processing in step S1107 regarding whether or not the shooting composition is appropriate is the same as the determination processing regarding whether or not the determination conditions (b1) to (b3) are satisfied, described in step S406 in FIG. 4, and accordingly description will be omitted. In a case in which the shooting composition is appropriate, the processing advances to step S1109. In a case in which the shooting composition is not appropriate, the processing advances to step S1108.

In step S1108, the framing adjusting unit 306 adjusts the framing. Specifically, the framing adjusting unit 306 generates driving information for adjusting the framing, and transmits the driving information that is generated to the drive unit 107. The drive unit 107 can adjust the framing on the basis of the driving information that is received.

A specific example of processing in step S1108 will be described with reference to FIGS. 12B and 12C. In FIG. 12B, the real object region 1204 is included within the angle of view 1201, but the virtual object region 1207 after the predetermined amount of time is out of the angle of view 1201. Also, the real object region 1204 encompassing the real object and the virtual object region 1207 encompassing the virtual object are not present at the middle of the angle of view 1201, but rather to one side. The shooting determining unit 305 determines that the shooting composition of the combined image in FIG. 12B is not appropriate.

In the example in FIG. 12C, the framing adjusting unit 306 adjusts the zoom to the wide-angle side such that the entirety of the virtual object region 1207 will be detected within the angle of view 1210. Also, the framing adjusting unit 306 performs adjustment by rotating the pan axis to the left, such that the real object and the virtual object region 1207 are situated at the middle of an angle of view 1210, and fit in the combined image. The framing adjusting unit 306 generates driving information for adjusting the framing, which is transmitted to the drive unit 107. The drive unit 107 adjusts the framing in accordance with the driving information, and thereby can perform framing control so as to achieve the appropriate shooting composition illustrated in FIG. 12C.

In step S1109, the shooting determining unit 305 determines whether or not shooting can be performed of the real image for generating the combined image for recording, on the basis of whether or not shooting is appropriate. The determination processing in step S1109 regarding whether or not shooting is appropriate is the same as the determination processing regarding whether or not the determination conditions (a1) to (a3) are satisfied, described in step S406 in FIG. 4, and accordingly description will be omitted. In a case in which shooting is appropriate, the processing advances to step S408. In a case in which shooting is not appropriate, the processing returns to step S401 and step S403.

Note that in a case in which it is sufficient to be able to avoid collision of the real object and the virtual object by offsetting the timing of acquiring the real object and the timing of generating the virtual object, the framing adjustment processing of steps S1107 and S1108 may be omitted.

In step S408, the timing control unit 1002 specifies the timing determined to be appropriate for shooting in step S1109 to the image-capturing unit 106, as acquisition timing for the real image. The image-capturing unit 106 performs image-capturing processing for acquiring the real image for recording at the timing specified by the timing control unit 1002. In step S409, the image processing unit 301 of the information processing unit 102 performs image processing with respect to the real image for recording that is acquired in the image-capturing processing of step S408.

In step S1110, the timing control unit 1002 stands by until the clock time of the generating timing of the virtual image recorded in step S1106. Upon the clock time recorded in step S1106 arriving, the timing control unit 1002 specifies the acquisition timing for the virtual image to the computing device 2 via the communication unit 103.

In step S410, the virtual image generating unit 302 acquires data of the virtual object from the communication unit 202 of the computing device 2 via the communication unit 103. The virtual image generating unit 302 generates the virtual image for recording, on the basis of the data of the virtual object that is acquired.

The communication unit 103 issues a request to the communication unit 202 at the timing of step S408, and the communication unit 202 of the computing device 2 transmits data for the virtual object that is present in the virtual space to the communication unit 103. The virtual image generating unit 302 extracts the data of the virtual object that is present in the shooting angle of view of the real image acquired in step S408, out of the data of the virtual object received by the communication unit 103, and generates the virtual image on the basis of the data of the virtual object that is extracted.

In step S412, the image combining unit 303 can generate the combined image for recording that is illustrated in FIG. 12D, by combining the real image obtained in step S409 and the virtual image obtained in step S411. The image combining unit 303 can perform combining of the real image and the virtual image by alpha blending, for example.

In step S413, the computing unit 101 determines whether or not to end shooting. In a case of not ending shooting, the processing returns to step S401 and step S403. The processing of FIG. 11 is repeated until there is an instruction to end shooting.

According to the third embodiment described above, the image-capturing device 1 can generate a combined image by shooting the real object at an optimal timing regardless of the current position of the virtual image, by predicting the position of the virtual object in the future. Also, the image-capturing device 1 can generate a combined image in which the state of the shooting angle of view and the objects (real object and virtual object) is suitable.

### Fourth Embodiment

A fourth embodiment is an embodiment in which, in a case where a real object and a virtual object that are not main objects collide (overlap), framing control is performed such that this real object and virtual object are out of the angle of view of the combined image. The configuration of the information processing unit 102 according to the fourth embodiment is the same as the configuration in the first embodiment illustrated in FIG. 3, and accordingly repetitive description will be omitted. The image-capturing device 1 according to the fourth embodiment can obtain suitable images by placing the objects (real object and virtual object) at which the collision is occurring so as to be out of the angle of view.

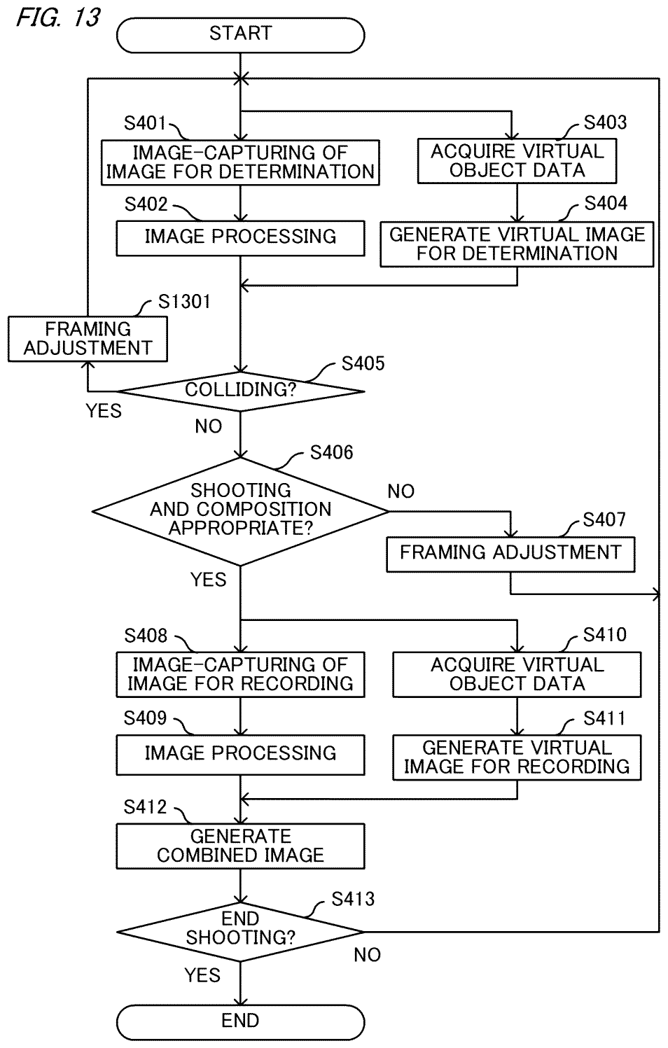

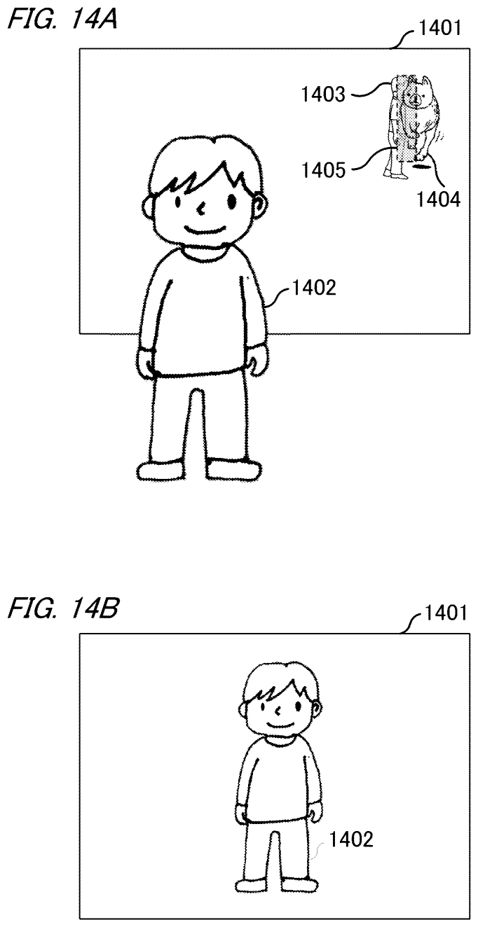

FIG. 13 is a flowchart exemplifying image combining processing according to the fourth embodiment. The image combining processing according to the fourth embodiment differs from the image combining processing according to the first embodiment shown in FIG. 4 with respect to the processing of step S405, and processing of an additional step S1301. Collision determination in step S405 and framing control in step S1301, according to the fourth embodiment, will be described with reference to FIGS. 14A and 14B.

In step S405, the collision determining unit 304 determines whether or not a real object that is an object other than a main object that is the object of shooting is colliding with a virtual object. FIG. 14A illustrates an example of a combined image in which a real image and a virtual image are combined. The combined image illustrated in FIG. 14A includes, within an angle of view 1401, a real object 1402 that is the main object and is the object of shooting, a real object 1403 other than the main object, and a virtual object 1404. A region 1405 indicates overlapping of the real object 1403 and the virtual object 1404. The region 1405 is found from a rectangular region indicating the real object region that is omitted from illustration, and a rectangular region indicating the virtual object region, in the same way as in the first embodiment.

The collision determining unit 304 detects the main object that is a real object that is the object of shooting, from the real image by a known technique. The collision determining unit 304 can detect the main object by performing feature point matching using an image indicating the main object that is registered in the primary storage unit 104 in advance, for example. Note that detection of the main object may be executed by the image processing unit 301.

In step S1301, the framing adjusting unit 306 generates driving information such that the region 1405 in which the real object 1403 and the virtual object 1404 are overlapping are out of the angle of view. The driving information includes, for example, driving parameters for zooming, driving parameters for the iris (diaphragm), rotation parameters regarding the pan axis, the tilt axis, and the roll axis, and so forth. Such driving information is found by known computation methods. The framing adjusting unit 306 transmits the generated driving information to the drive unit 107. The framing adjusting unit 306 can adjust the framing by controlling the drive unit 107 by the driving information.

The framing adjusting unit 306 generates the driving information such that the following control conditions (d1), (d2), and (d3) are satisfied.
(d1) The real object that is the object of shooting is detected in its entirety.
(d2) The size of real object that is the object of shooting (the area of the region thereof) is larger than a predetermined threshold value.
(d3) A difference between (the middle of the region of) real object that is the object of shooting and the middle of the angle of view is smaller than a predetermined threshold value.

In the example in FIG. 14B, the framing adjusting unit 306 adjusts the zoom to the wide-angle side, such that the entirety of the real object 1402 that is the object of shooting is detected. Also, the framing adjusting unit 306 performs adjustment by rotating the pan axis to the left and rotating the tilt axis downward, such that the overlapping region 1405 is placed out of the angle of view 1401. The framing adjusting unit 306 generates driving information such that the control conditions (d1) to (d3) are satisfied and the overlapping region 1405 is out of the angle of view 1401, which is transmitted to the drive unit 107. The drive unit 107 adjusts the framing in accordance with the driving information, and thereby can perform framing control so as to achieve the appropriate shooting composition illustrated in FIG. 14B.

Note that the framing adjusting unit 306 may gradually adjust the framing by repeating the processing of steps S401 to S407 and S1301 with respect to a plurality of frames. Also, in a case in which the real object that is the object of shooting is not detected, the framing adjusting unit 306 may find driving information for placing middle coordinates of the overlapping region 1405 out of the angle of view 1401 by a known technique.

According to the fourth embodiment described above, the image-capturing device 1 can generate a combined image in a state in which a real object and a virtual object other than the main object are not colliding, regardless of a real object that is a main object. Also, the image-capturing device 1 can generate a combined image in which the state of the shooting angle of view and the objects (real object and virtual object) is suitable.

Note that while the combining processing of the real image and the virtual image in the fourth embodiment has been described as being intended for generating a combined image for recording, this is not limited to cases of intending recording. The image-capturing device 1 may have an image display unit such as a display or the like, and may display the combined image as a live view image.

### Fifth Embodiment

A fifth embodiment is an embodiment in which whether or not a real object and a virtual object that are not main objects will move and collide is predicted, and in a case of predicting that they will collide, framing control is performed such that the position where the real object and the virtual object collide is out of the angle of view of the combined image. The configuration of the information processing unit 102 in the fifth embodiment is the same as the configuration in the first embodiment illustrated in FIG. 3, and accordingly repetitive description will be omitted.

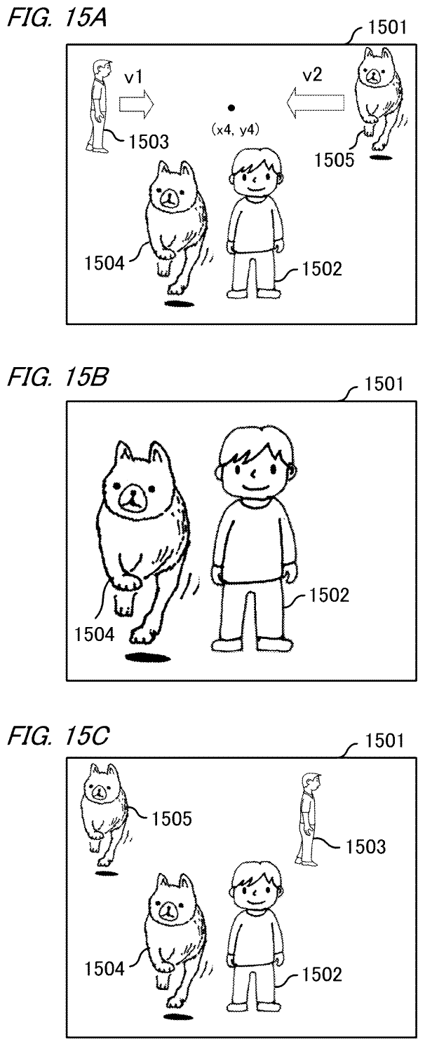

The image combining processing according to the fifth embodiment is the same as the flow of the image combining processing according to the fourth embodiment shown in FIG. 13, except for the processing of steps S405 and S1301, and accordingly repetitive description will be omitted. Collision determination in step S405 and framing control in step S1301, according to the fifth embodiment, will be described with reference to FIGS. 15A to 15C.

In step S405, the collision determining unit 304 uses position information and movement amount information of the real object and the virtual object, and determines whether or not the two objects will collide in the future. The collision determining unit 304 predicts the coordinates of the position where collision will occur.

FIG. 15A illustrates an example of a combined image in which a real image and a virtual image are combined. The combined image illustrated in FIG. 15A includes, within an angle of view 1501, a real object 1502 that is the main object and is the object of shooting, a real object 1503 other than the main object, a virtual object 1504 that is the object of shooting, and a virtual object 1505 that is different from the virtual object 1504. In the same way as in FIGS. 5A and 5B, each of the objects is detected by a rectangular region, omitted from illustration, encompassing the respective objects.

The collision determining unit 304 finds respective movement amounts v1 and v2 of the real object 1503 other than the main object, and the virtual object 1505, by a known technique. The collision determining unit 304 can find the movement amounts from difference in position among frames, for example. Also, regarding virtual objects, the collision determining unit 304 may acquire the movement amounts on the basis of data of virtual objects acquired from the computing device 2.

The collision determining unit 304 determines whether or not the following determination conditions (e1) and (e2) are satisfied.
(e1) A difference in coordinates of the respective rectangular regions of the real object 1503 and the virtual object 1505 will become smaller than a predetermined threshold value, a predetermined frame count later
(e2) A relative movement amount of the real object 1503 and the virtual object 1505 regarding which collision prediction is performed is smaller than a predetermined threshold value

In a case in which both of the determination conditions (e1) and (e2) are satisfied in the state in FIG. 15A, the collision determining unit 304 determines that the real object 1503 and the virtual object 1505 will collide. Coordinates (x4, y4) of the position at which the collision is predicted is calculated as a bisecting point of middle coordinates of each of the rectangular region indicating the real object 1503 and the rectangular region indicating the virtual object 1505 at the point that the determination conditions (e1) and (e2) are satisfied, for example. In a case in which at least one of the determination conditions (e1) and (e2) is not satisfied, the collision determining unit 304 determines that the real object 1503 and the virtual object 1505 will not collide.

In a case in which determination is made that the real object 1503 and the virtual object 1505 will collide, in step S1301, the framing adjusting unit 306 performs framing control such that the coordinates (x4, y4) are placed out of the angle of view 1501, as illustrated in FIG. 15B. The framing adjusting unit 306 calculates, as driving information for placing the coordinates (x4, y4) out of the angle of view 1501, driving parameters for zooming, driving parameters for the iris (diaphragm), rotation parameters regarding the pan axis, the tilt axis, and the roll axis, and so forth. The framing adjusting unit 306 can adjust the framing by controlling the drive unit 107 by the driving information.

Note that the framing adjusting unit 306 may gradually adjust the framing by repeating the processing of steps S401 to S407 and S1301 with respect to a plurality of frames. Also, in a case in which the real object that is the object of shooting is not detected, the framing adjusting unit 306 may find driving amount for placing the coordinates (x4, y4) of the position at which the collision is predicted to occur out of the angle of view 1501 by a known technique.

As illustrated in FIG. 15C, in a case in which determination is made that the real object 1503 and the virtual object 1505 will not collide, the framing adjusting unit 306 does not perform framing control. In a case in which determination is made that the real object 1503 and the virtual object 1505 will not collide, the image-capturing device 1 may stand by until the real object 1503 and the virtual object 1505 are out of the angle of view 1501, and then generate the combined image.

According to the fifth embodiment described above, the image-capturing device 1 can generate a combined image with no inconsistency occurring in positional relation, by predicting in advance whether or not a real object and a virtual object will collide. Note that while the combining processing of the real image and virtual image in the fifth embodiment has been described as being intended for generating a combined image for recording, this is not limited to cases of intending recording. The image-capturing device 1 may have an image display unit such as a display or the like, and may display the combined image as a live view image.

### Sixth Embodiment

A sixth embodiment is an embodiment in which framing control is performed regarding each of a real object and a virtual object. The image-capturing device 1 performs different framing control for each of the real object in real space and the virtual object in virtual space, whereby collision of the real object and the virtual object can be avoided.

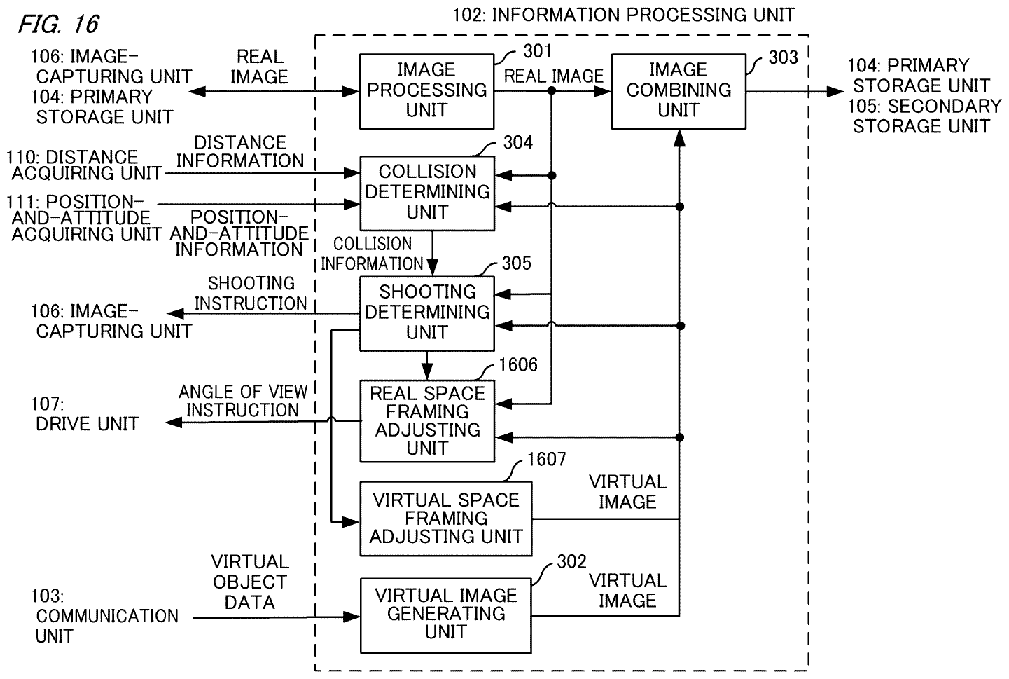

FIG. 16 is a diagram illustrating a configuration of the information processing unit 102 according to the sixth embodiment. The information processing unit 102 according to the sixth embodiment has, instead of the framing adjusting unit 306, a real space framing adjusting unit 1606 and a virtual space framing adjusting unit 1607. Configurations that are the same as those in FIG. 3 are denoted by the same signs, and repetitive description will be omitted.

The real space framing adjusting unit 1606 adjusts framing of real space. The virtual space framing adjusting unit 1607 adjusts framing of virtual space. In the sixth embodiment, the image-capturing device 1 performs different framing control for real space and virtual space, by the respective framing adjusting units. The image-capturing device 1 adjusts framing such that the real object included in the real space and the virtual object included in the virtual space do not collide, for example.

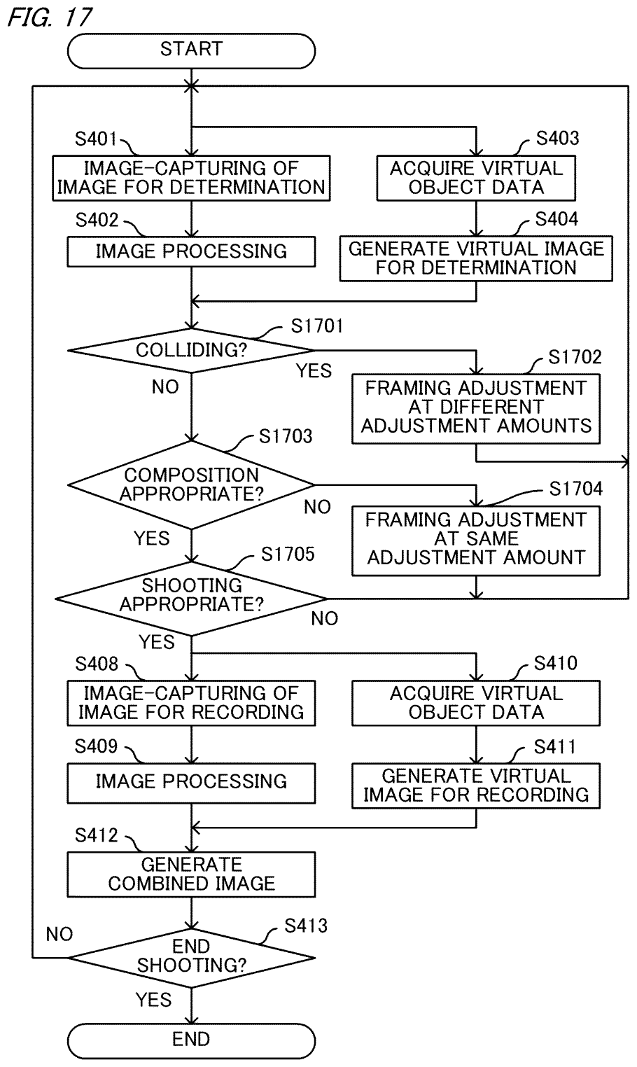

FIG. 17 is a flowchart exemplifying image combining processing according to the sixth embodiment. In the image combining processing according to the sixth embodiment, the processing of steps S401 to S404 and S408 to S413 is the same as the processing in the first embodiment shown in FIG. 4, and accordingly repetitive description will be omitted. The processing of steps S1701 to S1705, which are different from the first embodiment, will be described below.

In steps S401 to S404, the information processing unit 102 according to the sixth embodiment acquires a real image and a virtual image, for collision determination, in the same way as in the first embodiment.

In step S1701, the collision determining unit 304 determines whether or not the real object included in the real image and the virtual object included in the virtual image are colliding (are overlapped), using the real image and the virtual image for collision determination, acquired in steps S401 to S404. The method for collision determination is the same as the processing of step S405 in the first embodiment. In a case in which determination is made that the real object and the virtual object are colliding, the processing advances to step S1702. In a case in which determination is made that the real object and the virtual object are not colliding, the processing advances to step S1703.

In step S1702, the real space framing adjusting unit 1606 and the virtual space framing adjusting unit 1607 perform framing control of the real space and the virtual space by adjustment amounts that are different from each other. Here, the framing performed with respect to the real space and the framing performed with respect to the virtual space is processing for adjusting framing by controlling movement with respect to at least one of the seven axes of the pan axis, the tilt axis, the roll axis (a zoom axis), an up-down axis, a right-left axis, and a front-rear axis.

In step S1703, the shooting determining unit 305 determines whether or not the shooting composition is appropriate. That is to say, the shooting determining unit 305 performs determination regarding whether or not framing control that is appropriate for shooting is being performed with respect to the position of the object, and so forth. The shooting determining unit 305 can determine whether or not the shooting composition is appropriate, using the determination conditions (b1), (b2), and (b3) described in the first embodiment. In a case in which determination is made that the shooting composition is not appropriate, the processing advances to step S1704. In a case in which determination is made that the shooting composition is appropriate, the processing advances to step S1705.

In step S1704, the real space framing adjusting unit 1606 and the virtual space framing adjusting unit 1607 perform framing control of the real space and the virtual space by the same adjustment amount.

In step S1705, the shooting determining unit 305 performs determination regarding whether or not shooting is appropriate. That is to say, the shooting determining unit 305 determines whether or not the timing is best for the object (the state of the object is suitable for shooting). The shooting determining unit 305 can determine whether or not shooting is appropriate by using the determination conditions (a1), (a2), and (a3) described in the first embodiment.

In a case in which determination is made that shooting is not appropriate, the processing returns to step S401 and step S403. The information processing unit 102 repeats the processing of steps S401 to S404 and S1701 to S1705 until determination is made that shooting is appropriate. In a case in which determination is made that shooting is appropriate, the processing advances to step S408 and step S410. The processing of steps S408 to S413 is the same as the processing described in FIG. 4.

According to the sixth embodiment described above, in a case in which the real object and the virtual object are colliding, the image-capturing device 1 can combine the real image and the virtual image without waiting for the collision to be resolved. The image-capturing device 1 can shoot the real image and generate the virtual image, and generate a combined image, at a timing that is best for the object that was present at the time of collision of the real object and the virtual object. Accordingly, the image-capturing device 1 can perform image-capturing of the object (real object) in a more appropriate state, and can generate a combined image in which there is no collision with the virtual object.

Note that, while the combining processing of the real image and virtual image in the sixth embodiment has been described as being intended for generating a combined image for recording, this is not limited to cases of intending recording. The image-capturing device 1 may have an image display unit such as a display or the like, and may display the combined image as a live view image.

Although embodiments of the present invention have been described in detail, the present invention is not limited to these particular embodiments, and various forms that are made without departing from the spirit and scope of the present invention are also encompassed by the present invention. Further, the embodiments described above only illustrate an embodiment of the present invention, and the embodiments can be combined as appropriate.

Also, in the embodiments described above, description has been made regarding an example of a case in which the present invention is applied to a common automatic shooting camera, but the present invention is not limited to automatic shooting cameras, and is applicable to any image-capturing device that is capable of framing. That is to say, the present invention is applicable to a personal computer, a tablet terminal, a mobile telephone terminal, a portable image viewer, and a digital photo frame. Also, the present invention is applicable to a music player, a gaming console, various types of robots, a security camera, a network camera, an unmanned aircraft, a gimbal, and so forth.

According to the present invention, images can be obtained in which there is no inconsistency in positional relation between virtual objects and real objects, and in which the virtual objects and the real objects do not overlap.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-000971, filed on Jan. 9, 2024, which is hereby incorporated by reference herein in its entirety.

What is claimed is:

1. An information processing device comprising one or more processors and/or circuitry configured to:
execute acquisition processing of acquiring a real image in which real space is image-captured,
execute generating processing of generating, based on data of a virtual object placed in virtual space, a virtual image representing the virtual space in which the virtual object is placed,
execute combining processing of combining the real image and the virtual image, and generating a combined image, and
execute control processing in which, based on whether or not a real object included in the real image and the virtual object included in the virtual image overlap, framing control is performed to adjust positions of the real object and the virtual object in the combined image,
wherein, in the combining processing, the real image that is image-captured based on the framing control and the virtual image that is generated based on the framing control are combined.

2. The information processing device according to claim 1, wherein, in the control processing, in a case in which the real object and the virtual object do not overlap, the framing control is performed such that the real object and the virtual object fit in the combined image.

3. The information processing device according to claim 1, wherein, in the control processing, in a case in which a second real object that is different from the real object and a second virtual object that is different from the virtual object overlap, the framing control is performed such that the second real object and the second virtual object are out of an angle of view of the combined image.

4. The information processing device according to claim 1, wherein,
in the control processing,
prediction is performed regarding whether or not a second real object that is different from the real object and a second virtual object that is different from the virtual object move and collide, and
in a case of prediction that the second real object and the second virtual object collide, the framing control is performed such that a position at which the second real object and the second virtual object will collide is out of an angle of view of the combined image.

5. The information processing device according to claim 1, wherein, in the control processing, the framing control is performed for each of the real object and the virtual object.

6. The information processing device according to claim 1, wherein,
in the control processing, further, a first timing for acquiring the real image and a second timing for generating the virtual image are specified based on whether or not the real object and the virtual object overlap, and
in the combining processing, the real image acquired at the first timing based on the framing control, and the virtual image generated at the second timing based on the framing control, are combined.

7. An information processing device comprising one or more processors and/or circuitry configured to:
execute acquisition processing of acquiring a real image in which real space is image-captured,
execute generating processing of generating, based on data of a virtual object placed in virtual space, a virtual image representing the virtual space in which the virtual object is placed,
execute control processing of, based on whether or not a real object included in the real image and the virtual object included in the virtual image overlap, controlling a first timing of acquiring the real image and a second timing for generating the virtual image, and
execute combining processing of combining the real image acquired at the first timing and the virtual image generated at the second timing and generating a combined image.

8. The information processing device according to claim 6, wherein, in the control processing, a position of the virtual object after a predetermined amount of time is predicted based on movement information of the virtual object that is included in the data of the virtual object, and whether or not the real object and the virtual object placed at the predicted position overlap is determined.

9. The information processing device according to claim 8, wherein, in the control processing, in a case in which the real object and the virtual object overlap, a position of the virtual object after the predetermined amount of time is predicted.

10. The information processing device according to claim 8, wherein, in the control processing, in a case in which the real object and the virtual object placed at the predicted position do not overlap, a timing after the predetermined amount of time is specified as the second timing.

11. The information processing device according to claim 8, wherein, in the combining processing, in a case in which the real object and the virtual object are overlapped even after a prediction period that is set in advance elapses from a clock time of acquiring the real image, the real image and the virtual image are not combined.

12. The information processing device according to claim 1, wherein, in the combining processing, in a case in which the real object and the virtual object overlap, the real image and the virtual image are not combined.

13. The information processing device according to claim 1, wherein, in the control processing, whether or not the real object and the virtual object overlap in a two-dimensional plane of the combined image is determined.

14. The information processing device according to claim 1, wherein, in the control processing, whether or not the real object and the virtual object overlap in a three-dimensional space in which the real space and the virtual space are merged, is determined.

15. The information processing device according to claim 14, wherein, in the control processing, coordinates of the virtual object in the three-dimensional space are acquired based on coordinates of the real object in the three-dimensional space.

16. The information processing device according to claim 15, wherein, in the control processing, the coordinates of the real object in the three-dimensional space are acquired based on a position and attitude of an image-capturing device that performs image-capturing of the real space, and a distance from the image-capturing device to the real object.

17. The information processing device according to claim 1, wherein clock time in the virtual space is synchronized with clock time in the real space.

18. An information processing method, comprising:
acquiring a real image in which real space is image-captured;
generating, based on data of a virtual object placed in virtual space, a virtual image representing the virtual space in which the virtual object is placed;
combining the real image and the virtual image, and generating a combined image; and
performing framing control, based on whether or not a real object included in the real image and the virtual object included in the virtual image overlap, to adjust positions of the real object and the virtual object in the combined image,
wherein, in the combining, the real image that is image-captured based on the framing control and the virtual image that is generated based on the framing control are combined.

19. An information processing method, comprising:
acquiring a real image in which real space is image-captured;
generating, based on data of a virtual object placed in virtual space, a virtual image representing the virtual space in which the virtual object is placed,
controlling a first timing of acquiring the real image and a second timing for generating the virtual image, based on whether or not a real object included in the real image and the virtual object included in the virtual image overlap; and
combining the real image acquired at the first timing and the virtual image generated at the second timing and generating a combined image.

20. A non-transitory computer readable medium that stores a program, wherein the program causes a computer to execute an information processing method comprising:
acquiring a real image in which real space is image-captured;
generating, based on data of a virtual object placed in virtual space, a virtual image representing the virtual space in which the virtual object is placed;
combining the real image and the virtual image, and generating a combined image; and
performing framing control, based on whether or not a real object included in the real image and the virtual object included in the virtual image overlap, to adjust positions of the real object and the virtual object in the combined image,
wherein, in the combining, the real image that is image-captured based on the framing control and the virtual image that is generated based on the framing control are combined.

21. A non-transitory computer readable medium that stores a program, wherein the program causes a computer to execute an information processing method comprising:
acquiring a real image in which real space is image-captured;
generating, based on data of a virtual object placed in virtual space, a virtual image representing the virtual space in which the virtual object is placed,
controlling a first timing of acquiring the real image and a second timing for generating the virtual image, based on whether or not a real object included in the real image and the virtual object included in the virtual image overlap; and
combining the real image acquired at the first timing and the virtual image generated at the second timing and generating a combined image.
